(19) United States
(12) Patent Application Publication
(10) Pub. No.: US 2016/0216877 A1
(43) Pub. Date: Jul. 28, 2016

(54) METHOD AND DEVICE FOR VISUALLY PRESENTING DATA PRELOADING

(71) Applicants: Simon EKSTRAND, Eslov (SE); Huawei Technologies Co., Ltd., Shenzhen (CN)

(72) Inventors: Simon EKSTRAND, Eslov (SE); Zhilin LIU, Shenzhen (CN)

(21) Appl. No.: 14/981,311

(22) Filed: Dec. 28, 2015

Related U.S. Application Data
(63) Continuation of application No. PCT/CN2015/085687, filed on Jul. 31, 2015.

(30) Foreign Application Priority Data
Jan. 23, 2015 (CN) 201510037273.8

(51) Int. Cl. G06F 3/0484; G06F 3/0482; G06F 3/0481

(52) U.S. Cl. CPC G06F 3/04847; G06F 3/04817; G06F 3/0482

(57) ABSTRACT

Embodiments of the present disclosure provide a method and a device for visually presenting data preloading, where the method includes: acquiring a current playback progress of digital media content; presenting a first icon on a progress bar of a player of the digital media content; determining a parameter that is used to indicate a data preloading speed of the digital media content; and presenting, at least one data point in the part, of the progress bar, that has not been played, so as to indicate the data preloading speed. According to the method and the device for visually presenting data preloading provided in the embodiments of the present disclosure, a parameter that is used to indicate a data preloading speed is acquired; therefore, visual presentation of data preloading can be implemented, so that a user can know the data preloading speed, and user experience can be effectively improved.

### CROSS-REFERENCE TO RELATED APPLICATIONS

This application is a continuation of International Patent Application No. PCT/CN2015/085687, filed on Jul. 31, 2015, which claims priority to Chinese Patent Application No. 201510037273.8, filed on Jan. 23, 2015, both of which are hereby incorporated by reference in their entireties.

### TECHNICAL FIELD

Embodiments of the present disclosure relate to the multimedia field, and more specifically, to a method and a device for visually presenting data preloading.

### BACKGROUND

At present, a user may watch or read different kinds of digital media content, for example, a movie and TV series, a music video, or an ebook, by using various electronic devices. However, because of a limitation of network bandwidth, when viewing, e.g., watching or reading, the media content, the user sometimes has to wait for buffering because of a low network speed. To reduce time for waiting for buffering, in a current technology, a method for preloading digital media content that has not been played is used: The media content that has not been played is stored in a system in advance in order to be smoothly played subsequently, and a data volume that is loaded in advance is presented by using a loading progress bar. However, the user can know only a total loading volume, instead of easily knowing a loading speed, by using the loading progress bar; therefore, the user cannot make a decision, for example, on whether to continue watching or reading or to watch or read later, and user experience is poor.

### SUMMARY

Embodiments of the present disclosure provide a method and a device for visually presenting data preloading, with which a data preloading speed can be presented and user experience can be improved.

A first aspect provides a method for visually presenting data preloading, including:

acquiring a current playback progress of digital media content;

presenting a first icon on a progress bar of a player of the digital media content according to the current playback progress, where the first icon divides the progress bar into a part that has been played and a part that has not been played;

determining a parameter that is used to indicate a data preloading speed of the digital media content; and

presenting, according to the parameter, at least one data point in the part, of the progress bar, that has not been played, so as to indicate the data preloading speed.

With reference to the first aspect, in a first possible implementation manner of the first aspect, a preloading progress bar is further presented in the part, of the progress bar, that has not been played; and

the method further includes:

presenting in the part, of the progress bar, that has not been played that the at least one data point successively integrates into the preloading progress bar from right to left.

With reference to the first aspect or the first possible implementation manner of the first aspect, in a second possible implementation manner of the first aspect, the parameter is a data volume preloaded per unit time; and

the presenting, according to the parameter, at least one data point in the part, of the progress bar, that has not been played includes:

presenting the at least one data point in the part that has not been played, where a size of each data point is used to represent a size of a data volume that is preloaded per unit time corresponding to each data point.

With reference to the second possible implementation manner of the first aspect, in a third possible implementation manner of the first aspect, the at least one data point is arranged at equal space in the part, of the progress bar, that has not been played.

With reference to the first aspect or the first possible implementation manner of the first aspect, in a fourth possible implementation manner of the first aspect, the parameter is time required for loading a unit data volume; and

the presenting, according to the parameter, at least one data point in the part, of the progress bar, that has not been played includes:

presenting the at least one data point in the part that has not been played, where a distance between adjacent data points represents the time required for loading the unit data volume.

With reference to the fourth possible implementation manner of the first aspect, in a fifth possible implementation manner of the first aspect, the at least one data point has an equal size.

With reference to the first possible implementation manner of the first aspect, in a sixth possible implementation manner of the first aspect, the method further includes:

when each data point integrates into the preloading progress bar, presenting a second blinking icon in a location on which each data point is located.

With reference to the first aspect and any one of the first to the sixth possible implementation manners of the first aspect, in a seventh possible implementation manner of the first aspect, the method further includes:

presenting a third icon, where a rotation speed of the third icon is used to indicate the data preloading speed of the digital media content.

With reference to the seventh possible implementation manner of the first aspect, in an eighth possible implementation manner of the first aspect, a color of the third icon changes as the rotation speed of the third icon changes.

A second aspect provides a device for visually presenting data preloading, where the device includes:

an acquiring module, configured to acquire a current playback progress of digital media content;

a first presentation module, configured to present a first icon on a progress bar of a player of the digital media content according to the current playback progress acquired by the acquiring module, where the first icon divides the progress bar into a part that has been played and a part that has not been played;

a determining module, configured to determine a parameter that is used to indicate a data preloading speed of the digital media content; and

a second presentation module, configured to present, according to the parameter determined by the determining module, at least one data point in the part, of the progress bar, that has not been played and is presented by the first presentation module, so as to indicate the data preloading speed.

With reference to the second aspect, in a first possible implementation manner of the second aspect, a preloading progress bar is further presented in the part, of the progress bar, that has not been played and is presented by the first presentation module and; and

the device further includes:

a third presentation module, configured to present in the part, of the progress bar, that has not been played that the at least one data point successively integrates into the preloading progress bar from right to left.

With reference to the second aspect or the first possible implementation manner of the second aspect, in a second possible implementation manner of the second aspect, the parameter determined by the determining module is a data volume preloaded per unit time; and

the second presentation module is specifically configured to present the at least one data point in the part that has not been played, where a size of each data point is used to represent a size of a data volume that is preloaded per unit time corresponding to each data point.

With reference to the second possible implementation manner of the second aspect, in a third possible implementation manner of the second aspect, the at least one data point is arranged at equal space in the part, of the progress bar, that has not been played.

With reference to the second aspect or the first possible implementation manner of the second aspect, in a fourth possible implementation manner of the second aspect, the parameter determined by the determining module is time required for loading a unit data volume; and

the second presentation module is specifically configured to present the at least one data point in the part that has not been played, where a distance between adjacent data points represents the time required for loading the unit data volume.

With reference to the fourth possible implementation manner of the second aspect, in a fifth possible implementation manner of the second aspect, the at least one data point has an equal size.

With reference to the first possible implementation manner of the second aspect, in a sixth possible implementation manner of the second aspect, the device further includes:

a fourth presentation module, configured to: when each data point integrates into the preloading progress bar, present a second blinking icon in a location on which each data point is located.

With reference to the second aspect and any one of the first to the sixth possible implementation manners of the second aspect, in a seventh possible implementation manner of the second aspect, the device further includes:

a fifth presentation module, configured to present a third icon, where a rotation speed of the third icon is used to indicate the data preloading speed of the digital media content.

With reference to the seventh possible implementation manner of the second aspect, in an eighth possible implementation manner of the second aspect, a color of the third icon changes as the rotation speed of the third icon changes.

Based on the foregoing technical solution, according to the method and the device for visually presenting data preloading provided in the embodiments of the present disclosure, a parameter that is used to indicate a data preloading speed is acquired, and at least one data point is presented according to the parameter; therefore, visual presentation of data preloading can be implemented, so that a user can know the data preloading speed, and user experience can be effectively improved.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 shows a schematic flowchart of a method for visually presenting data preloading according to an embodiment of the present disclosure;

FIG. 2 shows a schematic diagram of a method for visually presenting data preloading according to an embodiment of the present disclosure;

FIG. 3 shows a schematic block diagram of a device for visually presenting data preloading according to an embodiment of the present disclosure; and

FIG. 4 shows another schematic block diagram of a device for visually presenting data preloading according to an embodiment of the present disclosure.

### DESCRIPTION OF EMBODIMENTS

The following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

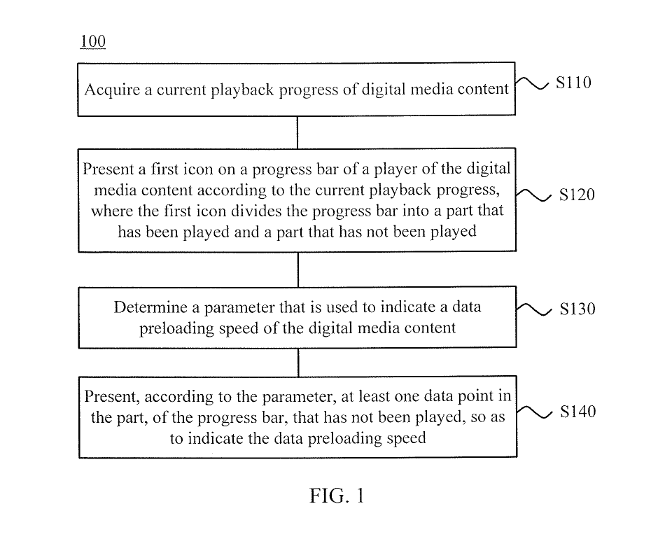

FIG. 1 shows a method 100 for visually presenting data preloading according to an embodiment of the present disclosure. The method 100 includes the following steps:

S110. Acquire a current playback progress of digital media content.

S120. Present a first icon on a progress bar of a player of the digital media content according to the current playback progress, where the first icon divides the progress bar into a part that has been played and a part that has not been played.

S130. Determine a parameter that is used to indicate a data preloading speed of the digital media content.

S140. Present, according to the parameter, at least one data point in the part, of the progress bar, that has not been played, so as to indicate the data preloading speed.

According to the method for visually presenting data preloading provided in this embodiment of the present disclosure, a parameter that is used to indicate a data preloading speed is acquired, and at least one data point is presented according to the parameter, which enables a user to know a current data-loading speed and helps the user make a further decision, for example, to continue watching or reading or to watch or read later, so that user experience can be effectively improved.

The digital media content involved in this embodiment of the present disclosure includes but is not limited to a video, audio, and an electronic book.

In S110, the current playback progress of the digital media content is acquired. Specifically, the current playback progress refers to a location of a current frame of the digital media content in an entire length of the digital media content, where content before the current frame is content that has been played, and content after the current frame is content that has not been played.

It should be understood that content represented by the current playback progress is not necessarily content that the user actually watches/reads. For example, in the content represented by the current playback progress, there may be content played by the user in a manner of fast forwarding, rewinding, or dragging the progress bar.

In S120, the first icon is presented on the progress bar of the player of the digital media content according to the current playback progress of the data media content, where the first icon is used to divide the progress bar into the part that has been played and the part that has not been played. The progress bar of the player of the digital media content is used to indicate a played progress and a to-be-played progress that are of the digital media content.

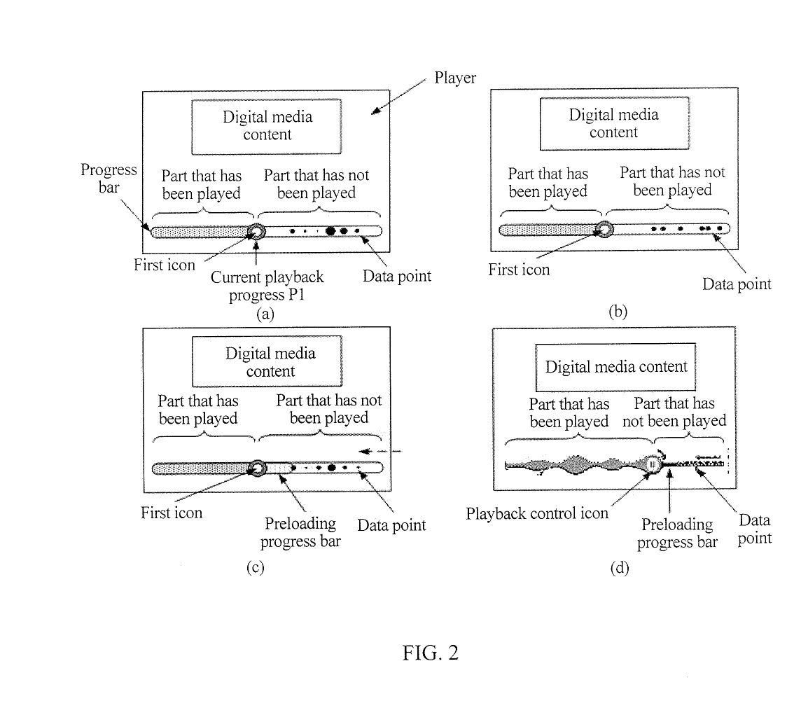

Specifically, as shown in FIG. 2(a), P1 is the current playback progress of the digital media content, and the first icon is presented in the location P 1, so as to divide the progress bar into the part that has been played and the part that has not been played.

In S130, the parameter that is used to indicate the data preloading speed of the digital media content is determined. Specifically, the parameter may be a data volume loaded per unit time in the part, of the digital media content, that has not been played, or may be time required for loading a unit data volume, which is not limited in this embodiment of the present disclosure.

It should be understood that the data preloading speed involved in this embodiment of the present disclosure is not completely equivalent to a network speed. Specifically, a current data-preloading speed of the digital media content may be acquired according to a current network speed (or network bandwidth).

In S140, the at least one data point is presented, according to the parameter, in the part, of the progress bar, that has not been played, so as to indicate the data preloading speed. Specifically, a manner of presenting the at least one data point in the part that has not been played may indicate the parameter that is used to indicate the data preloading speed.

In this embodiment of the present disclosure, according to different types of the acquired parameter that is used to indicate the data preloading speed, for example, a volume that is loaded per unit time and time required for loading a unit data volume, the at least one data point may have different presentation manners in the part, of the progress bar, that has not been played.

Optionally, in this embodiment of the present disclosure, the parameter is a data volume that is preloaded per unit time.

The step S140 of the presenting, according to the parameter, at least one data point in the part, of the progress bar, that has not been played includes:

S141. Present the at least one data point in the part that has not been played, where a size of each data point is used to represent a size of a data volume that is preloaded per unit time corresponding to each data point.

Specifically, a larger data volume that is preloaded per unit time indicates a larger data point, and a smaller data volume that is preloaded per unit time indicates a smaller data point.

It should be understood that the data point may be of various shapes, for example, a circle, a square, or another shape, which is not limited in this embodiment of the present disclosure.

Optionally, in this embodiment of the present disclosure, the at least one data point is arranged at equal space in the part, of the progress bar, that has not been played.

Specifically, at an interval of a unit time, a data point is presented in the part, of the progress bar, that has not been played, where the data point is used to indicate a data volume that is preloaded within the unit time.

As shown in FIG. 2(a), M data points are presented in the part, of the progress bar, that has not been played. A size of each data point represents a size of a data volume that is preloaded within a unit time corresponding to the data point, and absolute distances between adjacent data points are the same, that is, distances between centers of data points are the same. As an example instead of a limitation, M is 6 in FIG. 2(a).

Optionally, in this embodiment of the present disclosure, the parameter is time required for loading a unit data volume.

The step S140 of the presenting, according to the parameter, at least one data point in the part, of the progress bar, that has not been played includes:

S142. Present the at least one data point in the part that has not been played, where a distance between adjacent data points represents the time required for loading the unit data volume.

Specifically, a shorter time required for loading the unit data volume indicates a shorter distance between adjacent data points, and a longer time required for loading the unit data volume indicates a longer distance between adjacent data points.

Optionally, in this embodiment of the present disclosure, the at least one data point has an equal size.

Specifically, a size of each data point of the at least one data point represents a unit data volume.

Specifically, as shown in FIG. 2(b), N data points are presented in the part, of the progress bar, that has not been played, absolute distances (distances between centers of data points) between two adjacent data points are not completely the same, and sizes of the data points are the same. As an example instead of a limitation, N is 6 in FIG. 2(b).

It should be understood that S141 (as shown in FIG. 2(a)) may be seen as acquiring a data volume that is preloaded per unit time and presenting, at an equal time interval (the unit time), the at least one data point in the part, of the progress bar, that has not been played, where the size of each data point represents the size of the data volume that is preloaded within a corresponding time interval. S142 (as shown in FIG. 2(b)) may be seen as acquiring the time required for loading the unit data volume, that is, measuring duration each time a unit data volume is loaded; and presenting a data point each time a unit data volume completes loading, where by analogy, in the finally presented at least one data point, a distance between adjacent data points indicates duration during which a corresponding unit data volume is loaded. Both the two methods for presenting the data points described in S141 and S142 can enable the user to know a data preloading speed that is in a period of time.

In this embodiment of the present disclosure, the at least one data point presented in the part, of the progress bar, that has not been played may be static or dynamic, which is not limited in this embodiment of the present disclosure.

In a process of playing the digital media content, data preloading may be performed for content that has not been played, and the preloaded content is temporarily stored in a system.

Optionally, in this embodiment of the present disclosure, a preloading progress bar is further presented in the part, of the progress bar of the digital media content, that has not been played.

The method 100 further includes the following step:

S150. Present in the part, of the progress bar, that has not been played that the at , least one data point successively integrates into the preloading progress bar from right to left.

Specifically, the preloading progress bar is used to indicate a preloading progress, where the preloading progress refers to a location of the data preloading in the entire length of the digital media content.

Specifically, as shown in FIG. 2(c), the preloading progress bar is presented in the part, of the progress bar, that has not been played; and the at least one data point successively moves from the right side of the part, of the progress bar, that has not been played to the right side of the preloading progress bar, and successively integrates into the preloading progress bar. Equivalently, with integration of the data point, the preloading progress bar gets longer accordingly, where an increased length is corresponding to a size of an integrated data point. That is, as the data point integrates into the preloading progress bar, the preloading progress bar is continuously updated and gets longer.

Optionally, in this embodiment of the present disclosure, the method 100 further includes the following step:

S160. When each data point integrates into the preloading progress bar, present a second blinking icon in a location on which each data point is located.

Optionally, in this embodiment of the present disclosure, the method 100 further includes the following step:

S170. Present a third icon, where a rotation speed of the third icon is used to indicate the data preloading speed of the digital media content.

Optionally, in this embodiment of the present disclosure, a color of the third icon changes as the rotation speed of the third icon changes.

The third icon may be specifically a playback control icon of the player. As shown in FIG. 2(d), the playback control icon is presented in a current playback location, the playback control icon may rotate around a center point and move rightwards according to the data preloading speed, and the rotation speed is corresponding to the preloading speed. Specifically, for a data volume that is loaded per unit time, a larger data volume indicates faster rotation of the playback control icon; a smaller data volume indicates slower rotation of the playback control icon. Further, a different color may be further presented on the playback control icon according to the rotation speed.

Further, the part, of the progress bar, that has been played also presents different thickness according to the size of the data volume that is preloaded per unit time. As shown in FIG. 2(d), a larger data volume that is preloaded per unit time indicates a thicker progress bar; a smaller data volume that is preloaded per unit time indicates a thinner the progress bar.

When the user watches/reads the digital media content, the user may know, by means of visual presentation of data preloading provided in this embodiment of the present disclosure, a current data-preloading speed, so as to accurately determine whether, in a next step, to continue watching or reading, or to wait to watch or read later, or to choose another loading service such as acceleration and cloud loading to continue loading, thereby effectively improving user experience.

According to the method for visually presenting data preloading provided in this embodiment of the present disclosure, an operator may also intuitively present an advantage of a wideband product to a user. A platform for playing the digital media content may also smoothly recommend a service such as acceleration and cloud loading to the user.

Optionally, the method 100 for visually presenting data preloading provided in this embodiment of the present disclosure may be executed, for example, by a digital media content playback processor.

Specifically, when a user opens digital media content to watch or read, the digital media content playback processor begins to preload a part, of the digital media content, that has not been played; the processor acquires, according to a current network speed, a parameter that is used to indicate a data preloading speed of the digital media content, for example, a volume that is loaded per unit time or loading time required for loading a unit data volume; the processor presents at least one data point on a progress bar of a player of the digital media content according to the acquired parameter, and a specific presentation manner may be any one of or a combination of FIG. 2(a) to FIG. 2(d), which is not limited in this embodiment of the present disclosure, so that the user can know the data preloading speed by using the at least one data point.

It should be understood that the at least one data point involved in this embodiment of the present disclosure may be presented in a location of the part, of the progress bar of the player of the digital media content, that has not been played, or may be presented in another location of a user interface of the player, which is not limited in this embodiment of the present disclosure, provided that the user can know the current data-preloading speed in a process of watching or reading reading the digital media content.

It should be further understood that the data preloading speed involved in this embodiment of the present disclosure includes but is not limited to a data preloading speed at a current moment (a moment corresponding to a current playback frame), a data preloading speed within a preset period of time, and the like.

It should be further understood that in this embodiment of the present disclosure, provided that the parameter that is used to indicate the data preloading speed is acquired, for example, a size of a data volume that is preloaded per unit time or time required for loading a unit data volume is acquired, the at least one data point can be presented according to the parameter. It is not necessary to acquire a data preloading speed within an entire period of time.

Therefore, according to the method for visually presenting data preloading provided in this embodiment of the present disclosure, a parameter that is used to indicate a data preloading speed is acquired, and at least one data point is presented according to the parameter, which enables a user to know a current data-loading speed and helps the user make a further decision, for example, to continue watching or reading or to watch or read later, so that user experience can be effectively improved.

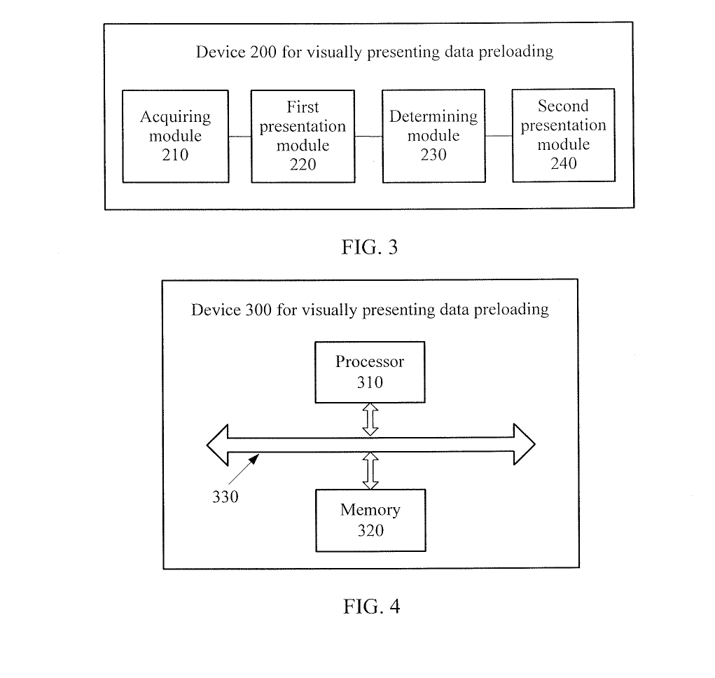

The foregoing describes in detail the method for visually presenting data preloading according to the embodiments of the present disclosure with reference to FIG. 1 and FIG. 2, and the following describes a device for visually presenting data preloading according to the embodiments of the present disclosure with reference to FIG. 3 and FIG. 4.

FIG. 3 shows a schematic block diagram of a device 200 for visually presenting data preloading according to an embodiment of the present disclosure. As shown in FIG. 3, the device 200 includes:

an acquiring module 210, configured to acquire a current playback progress of digital media content;

a first presentation module 220, configured to present a first icon on a progress bar of a player of the digital media content according to the current playback progress acquired by the acquiring module, where the first icon divides the progress bar into a part that has been played and a part that has not been played;

a determining module 230, configured to determine a parameter that is used to indicate a data preloading speed of the digital media content; and

a second presentation module 240, configured to present, according to the parameter determined by the determining module, at least one data point in the part, of the progress bar, that has not been played and is presented by the first presentation module, so as to indicate the data preloading speed.

Therefore, according to the device for visually presenting data preloading provided in this embodiment of the present disclosure, a parameter that is used to indicate a data preloading speed is acquired, and at least one data point is presented according to the parameter, which enables a user to know a current data-loading speed and helps the user make a further decision, for example, to continue watching or reading or to watch or read later, so that user experience can be effectively improved.

Optionally, in this embodiment of the present disclosure, a preloading progress bar is further presented in the part, of the progress bar, that has not been played and is presented by the first presentation module 220.

The device 200 further includes:

a third presentation module 250, configured to present in the part, of the progress bar, that has not been played that the at least one data point successively integrates into the preloading progress bar from right to left.

Optionally, in this embodiment of the present disclosure, the parameter determined by the determining module 230 is a data volume that is preloaded per unit time.

The second presentation module 240 is specifically configured to present the at least one data point in the part that has not been played, where a size of each data point is used to represent a size of a data volume that is preloaded per unit time corresponding to each data point.

Optionally, in this embodiment of the present disclosure, the at least one data point is arranged at equal space in the part, of the progress bar, that has not been played.

Optionally, in this embodiment of the present disclosure, the parameter determined by the determining module 230 is time required for loading a unit data volume.

The second presentation module 240 is specifically configured to present the at least one data point in the part that has not been played, where a distance between adjacent data points represents the time required for loading the unit data volume.

Optionally, in this embodiment of the present disclosure, the at least one data point has an equal size.

Optionally, in this embodiment of the present disclosure, the device 200 further includes:

a fourth presentation module 260, configured to: when each data point integrates into the preloading progress bar, present a second blinking icon in a location on which each data point is located.

Optionally, in this embodiment of the present disclosure, the device 200 further includes:

a fifth presentation module 270, configured to present a third icon, where a rotation speed of the third icon is used to indicate the data preloading speed of the digital media content.

Optionally, in this embodiment of the present disclosure, a color of the third icon changes as the rotation speed of the third icon changes.

Therefore, according to the device for visually presenting data preloading provided in this embodiment of the present disclosure, a parameter that is used to indicate a data preloading speed is acquired, and at least one data point is presented according to the parameter, which enables a user to know a current data-loading speed and helps the user make a further decision, for example, to continue watching or reading or to watch or read later, so that user experience can be effectively improved.

It should be understood that the foregoing and other operations and/or functions of modules in the device 200 for visually presenting data preloading according to this embodiment of the present disclosure are respectively used to achieve corresponding procedures of the methods in FIG. 1 and FIG. 2. For brevity, details are not described herein again.

It should be further understood that an embodiment of the present disclosure further provides a device 200 for visually presenting data preloading, which may be, for example, a smart terminal such as a video player or an ebook player that has a function of visually presenting data preloading.

As shown in FIG. 4, an embodiment of the present disclosure further provides a device 300 for visually presenting data preloading. The device 300 includes a processor 310, a memory 320, and a bus system 330. The processor 310 and the memory 320 are connected by using the bus system 330. The memory 320 is configured to store an instruction, and the processor 310 is configured to execute the instruction stored in the memory 320. The processor 310 is configured to: acquire a current playback progress of digital media content; present a first icon on a progress bar of a player of the digital media content according to the current playback progress, where the first icon divides the progress bar into a part that has been played and a part that has not been played; determine a parameter that is used to indicate a data preloading speed of the digital media content; and present, according to the parameter, at least one data point in the part, of the progress bar, that has not been played, so as to indicate the data preloading speed.

Therefore, according to the device for visually presenting data preloading provided in this embodiment of the present disclosure, a parameter that is used to indicate a data preloading speed is acquired, and at least one data point is presented according to the parameter, which enables a user to know a current data-loading speed and helps the user make a further decision, for example, to continue watching or reading or to watch or read later, so that user experience can be effectively improved.

Optionally, as an embodiment, a preloading progress bar is further presented in the part, of the progress bar, that has not been played. The processor 310 is configured to present in the part, of the progress bar, that has not been played that the at least one data point successively integrates into the preloading progress bar from right to left.

Optionally, as an embodiment, the parameter is a data volume that is preloaded per unit time. The processor 310 is configured to present the at least one data point in the part that has not been played, where a size of each data point is used to represent a size of a data volume that is preloaded per unit time corresponding to each data point.

Optionally, as an embodiment, the at least one data point is arranged at equal space in the part, of the progress bar, that has not been played.

Optionally, as an embodiment, the parameter is time required for loading a unit data volume.

The processor 310 is configured to present the at least one data point in the part that has not been played, where a distance between adjacent data points represents the time required for loading the unit data volume.

Optionally, as an embodiment, the at least one data point has an equal size.

Optionally, as an embodiment, the processor 310 is configured to: when each data point integrates into the preloading progress bar, present a second blinking icon in a location on which each data point is located.

Optionally, as an embodiment, the processor 310 is configured to present a third icon, where a rotation speed of the third icon is used to indicate the data preloading speed of the digital media content.

Optionally, as an embodiment, a color of the third icon changes as the rotation speed of the third icon changes.

It should be understood that in this embodiment of the present disclosure, the processor 310 may be a central processing unit (CPU), or the processor 310 may be another general purpose processor, a digital signal processor (DSP), an application-specific integrated circuit (ASIC), a field programmable gate array (FPGA), or another programmable logical device, discrete gate or transistor logical device, discrete hardware component, or the like. A general purpose processor may be a microprocessor or the processor may be any conventional processor and the like.

The memory 320 may include a read-only memory and a random access memory, and provides an instruction and data to the processor 310. A part of the memory 320 may further include a non-volatile random access memory. For example, the memory 320 may further store information about a device type.

The bus system 330 may further include a power bus, a control bus, a status signal bus, and the like, in addition to including a data bus. However, for clear description, various types of buses in the figure are marked as the bus system 330.

In an implementation process, steps in the foregoing methods may be completed by using an integrated logic circuit of hardware in the processor 310 or a software instruction. Steps of the methods disclosed with reference to the embodiments of the present disclosure may be directly executed and completed by means of a hardware processor, or may be executed and completed by using a combination of hardware and software modules in the processor. The software module may be located in a mature storage medium in the field, such as a random access memory, a flash memory, a read-only memory, a programmable read-only memory, an electrically-erasable programmable memory, or a register. The storage medium is located in the memory 320, and the processor 310 reads information in the memory 320 and completes the steps in the foregoing methods in combination with hardware of the processor. To avoid repetition, details are not described herein again.

Therefore, according to the device for visually presenting data preloading provided in this embodiment of the present disclosure, a parameter that is used to indicate a data preloading speed is acquired, and at least one data point is presented according to the parameter, which enables a user to know a current data-loading speed and helps the user make a further decision, for example, to continue watching or reading or to watch or read later, so that user experience can be effectively improved.

It should be understood that the device 300 for visually presenting data preloading according to this embodiment of the present disclosure may be corresponding to the device 200 for visually presenting data preloading provided in the embodiments of the present disclosure. The foregoing and other operations and/or functions of modules in the device 300 are respectively used to achieve corresponding procedures of the methods in FIG. 1 and FIG. 2. For brevity, details are not described herein again.

It should be understood that sequence numbers of the foregoing processes do not mean execution sequences in various embodiments of the present disclosure. The execution sequences of the processes should be determined according to functions and internal logic of the processes, and should not be construed as any limitation on the implementation processes of the embodiments of the present disclosure.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of⁻the foregoing system, apparatus, and unit, refer to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present disclosure essentially, or the part contributing to the prior art, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A method for visually presenting data preloading, comprising:
acquiring a current playback progress of a digital media content;
presenting a first icon on a progress bar of a player of the digital media content according to the current playback progress, wherein the first icon divides the progress bar into a part that has been played and a part that has not been played;
determining a parameter that is used to indicate a data preloading speed of the digital media content; and
presenting, according to the parameter, at least one data point in the part, of the progress bar, that has not been played, so as to indicate the data preloading speed.

2. The method according to claim 1, wherein a preloading progress bar is further presented in the part, of the progress bar, that has not been played; and
the method further comprises:
presenting in the part, of the progress bar, that has not been played that the at least one data point successively integrates into the preloading progress bar from right to left.

3. The method according to claim 1, wherein the parameter is a data volume preloaded per unit time; and
the presenting, according to the parameter, at least one data point in the part, of the progress bar, that has not been played comprises:
presenting the at least one data point in the part that has not been played, wherein a size of each data point represents a size of a data volume that is preloaded per unit time corresponding to each data point.

4. The method according to claim 3, wherein the at least one data point is arranged at equal spaces in the part, of the progress bar, that has not been played.

5. The method according to claim 1, wherein the parameter is a time required for loading a unit data volume; and
the presenting, according to the parameter, at least one data point in the part, of the progress bar, that has not been played comprises:
presenting the at least one data point in the part that has not been played, wherein a distance between adjacent data points represents the time required for loading the unit data volume.

6. The method according to claim 5, wherein each of the at least one data point has an equal size.

7. The method according to claim 2, wherein the method further comprises:
when each data point integrates into the preloading progress bar, presenting a second blinking icon in a location on which each data point is located.

8. The method according to claim 1, wherein the method further comprises:
presenting a third icon, wherein a rotation speed of the third icon indicates the data preloading speed of the digital media content.

9. The method according to claim 8, wherein a color of the third icon changes as the rotation speed of the third icon changes.

10. A device for visually presenting data preloading, comprising:
an acquiring module, configured to acquire a current playback progress of a digital media content;
a first presentation module, configured to present a first icon on a progress bar of a player of the digital media content according to the current playback progress acquired by the acquiring module, wherein the first icon divides the progress bar into a part that has been played and a part that has not been played;
a determining module, configured to determine a parameter that is used to indicate a data preloading speed of the digital media content; and
a second presentation module, configured to present, according to the parameter determined by the determining module, at least one data point in the part, of the progress bar, that has not been played and is presented by the first presentation module, so as to indicate the data preloading speed.

11. The device according to claim 10, wherein a preloading progress bar is further presented in the part, of the progress bar, that has not been played and is presented by the first presentation module; and
the device further comprises:
a third presentation module, configured to present in the part, of the progress bar, that has not been played that the at least one data point successively integrates into the preloading progress bar from right to left.

12. The device according to claim 10, wherein the parameter determined by the determining module is a data volume preloaded per unit time; and
the second presentation module is configured to present the at least one data point in the part that has not been played, wherein a size of each data point represents a size of a data volume that is preloaded per unit time corresponding to each data point.

13. The device according to claim 12, wherein the at least one data point is arranged at equal spaces in the part, of the progress bar, that has not been played.

14. The device according to claim 10, wherein the parameter determined by the determining module is a time required for loading a unit data volume; and
the second presentation module is configured to present the at least one data point in the part that has not been played, wherein a distance between adjacent data points represents the time required for loading the unit data volume.

15. The device according to claim 14, wherein each of the at least one data point has an equal size.

16. The device according to claim 11, wherein the device further comprises:
a fourth presentation module, configured to: when each data point integrates into the preloading progress bar, present a second blinking icon in a location on which each data point is located.

17. The device according to claim 10, wherein the device further comprises:
a fifth presentation module, configured to present a third icon, wherein a rotation speed of the third icon indicates the data preloading speed of the digital media content.

18. The device according to claim 17, wherein a color of the third icon changes as the rotation speed of the third icon changes.
